(19) United States
(12) Patent Application Publication
(10) Pub. No.: US 2019/0129615 A1
(43) Pub. Date: May 2, 2019

(54) APPARATUS AND METHOD FOR SIMPLIFYING REPEAT PERFORMANCE OF A PRIOR PERFORMED TASK BASED ON A CONTEXT OF A MOBILE DEVICE

(71) Applicant: Futurewei Technologies, Inc., Plano, TX (US)

(72) Inventors: ShivShankar Sundar, Santa Clara, CA (US); Brian Joseph Zeitler, Santa Clara, CA (US); Rong Amanda Hua, San Carlos, CA (US)

(21) Appl. No.: 15/798,013

(22) Filed: Oct. 30, 2017

(51) Int. Cl. G06F 3/06; G06F 3/0481; G06F 9/445; G06F 3/0484

(52) U.S. Cl. CPC G06F 3/061; G06F 3/0481; H04W 4/00; G06F 3/0484; G06F 9/4451

(57) ABSTRACT

A device and method are provided for enabling repeat performance of a prior performed task within an application. Usage of an application to perform a task via a mobile device is monitored. Configurations of the task via user interfaces (UIs) associated with the usage of the application are determined. A context of the mobile device is identified, including one or more conditions of the mobile device under which the application was activated to perform the task. A current context of the mobile device is tracked, including one or more conditions in which the mobile device is operating, and a relevance between the context and the current context is determined. In response to the relevance determined, a mobile UI is presented via the mobile device, to cause a repeat of performing the task with the configurations without activating at least one of the UIs associated with the usage of the application.

### FIELD OF THE INVENTION

The present invention relates to performing tasks within an application, and more particularly user interfaces (UIs) that make application tasks accessible to users for initiating performance thereof.

### BACKGROUND

Typically, when a user of a mobile device wants to perform a particular task within an application, the user must navigate through UIs specific to the application in order to access a particular UI of the application through which the user can configure and initiate the task. For example, the user may be required to first select an icon on a mobile UI of the mobile device which represents the application in order to first open a home page UI of the application on the user's mobile device. Then, the user may be required to select a menu item or link within the home page UI to navigate to the particular UI of the application through which the user can configure and initiate the task. This menu item or link selection may further be required to be repeated across multiple UIs of the application in order to navigate to the particular UI of the application through which the user can configure and initiate the task.

Thus, the user is generally required to repeat the aforementioned navigation through the UIs of the application each time the user wants to initiate the task. Further still, even when the user desires to repeat the task with a same configuration, the user may be required to enter configuration information for the task through the particular UI before initiating the task.

### SUMMARY

A device is provided for enabling repeat performance of a prior performed task within an application based on a current context of a mobile device. Included is a non-transitory memory storage comprising instructions, and one or more processors in communication with the memory, wherein the one or more processors execute the instructions to monitor usage of an application to perform a task via a mobile device. The one or more processors additionally execute the instructions to determine configurations of the task via user interfaces (UIs) associated with the usage of the application, the task being performed with the configurations specified according to the UIs. The one or more processors further execute the instructions to identify a context of the mobile device, the context including one or more conditions of the mobile device under which the application was activated to perform the task by a user of the mobile device. The one or more processors even further execute the instructions to track a current context of the mobile device, the current context including one or more conditions in which the mobile device is operating, and determine a relevance between the context and the current context. Still yet, the one or more processors execute the instructions to present, in response to the relevance determined, a mobile UI via the mobile device, the mobile UI to cause a repeat of performing the task with the configurations without activating at least one of the UIs associated with the usage of the application.

Also provided is a computer-implemented method for enabling repeat performance of a prior performed task within an application based on a current context of a mobile device. Usage of an application to perform a task via a mobile device is monitored. Configurations of the task via user interfaces (UIs) associated with the usage of the application are determined, the task being performed with the configurations specified according to the UIs. A context of the mobile device is identified, the context including one or more conditions of the mobile device under which the application was activated to perform the task by a user of the mobile device. A current context of the mobile device is tracked, the current context including one or more conditions in which the mobile device is operating, and a relevance between the context and the current context is determined. In response to the relevance determined, a mobile UI is presented via the mobile device, the mobile UI to cause a repeat of performing the task with the configurations without activating at least one of the UIs associated with the usage of the application.

A non-transitory computer-readable media is further provided which stores computer instructions that when executed by one or more processors, cause the one or more processors to perform steps for enabling repeat performance of a prior performed task within an application based on a current context of a mobile device. The steps include monitoring usage of an application to perform a task via a mobile device. The steps additionally include determining configurations of the task via user interfaces (UIs) associated with the usage of the application, the task being performed with the configurations specified according to the UIs. The steps further include identifying a context of the mobile device, the context including one or more conditions of the mobile device under which the application was activated to perform the task by a user of the mobile device. The steps include tracking a current context of the mobile device, the current context including one or more conditions in which the mobile device is operating, and determining a relevance between the context and the current context. Still yet, the steps include presenting, in response to the relevance determined, a mobile UI via the mobile device, the mobile UI to cause a repeat of performing the task with the configurations without activating at least one of the UIs associated with the usage of the application.

Optionally, in any of the preceding embodiments, the application is a mobile application installed on the mobile device.

Optionally, in any of the preceding embodiments, the application is one of: a messaging application, a media player, a merchant store, and a transportation reservation application.

Optionally, in any of the preceding embodiments, the UIs associated with the usage of the application are UIs of the application through which the user navigates to specify the configurations and initiate performance of the task with the configurations.

Optionally, in any of the preceding embodiments, an indication of the task is stored with the configurations and the context of the mobile device in a profile for the user, wherein the profile of the user is accessed to identify the context in order to determine the relevance between the context and the current context of the mobile device.

Optionally, in any of the preceding embodiments, the context of the mobile device includes one of: a location of the mobile device, and a time indicated by the mobile device.

Optionally, in any of the preceding embodiments, determining a relevance between the context and the current context includes determining whether the current context is within a predefined threshold difference from the context, and when the current context is within the predefined threshold difference from the context, the mobile UI is presented via the mobile device.

Optionally, in any of the preceding embodiments, the mobile UI is presented on a home screen of the mobile device.

Optionally, in any of the preceding embodiments, the mobile UI presented via the mobile device is an icon which when selected by the user causes the repeat of performing the task with the configurations without activating at least one of the UIs associated with the usage of the application.

Optionally, in any of the preceding embodiments, usage of an additional application to perform an additional task via a mobile device is monitored, configurations of the additional task via additional user interfaces (UIs) associated with the usage of the additional application are determined, the additional task being performed with the configurations specified according to the additional UIs. In addition, an additional context of the mobile device is identified, the additional context including one or more conditions of the mobile device under which the additional application was activated to perform the additional task by the user of the mobile device. Further, an additional relevance between the additional context and the current context is determined. Still yet, in combination with the mobile UI and in response to the additional relevance determined, an additional mobile UI is presented via the mobile device, the additional mobile UI to cause a repeat of performing the additional task with the configurations of the additional task without activating at least one of the additional UIs associated with the usage of the additional application.

To this end, in some optional embodiments, one or more of the foregoing features of the aforementioned device and/or method may simplify repeat performance of a prior performed task based on a current context of a mobile device. In particular, a specific mobile UI to cause repeat of the same prior performed task may only be provided when the task is relevant to a current context of the mobile device. This may ensure that the mobile UI specific to that task is presented at an appropriate time for the user. Further, by presenting the mobile UI to cause the same prior performed task to be repeated, the user may initiate repeat of the same prior performed task without having to again use one or more, or all, of the UIs of the application to configure and/or initiate the task. Thus, the mobile UI can simplify the actions the user needs to take to repeat the task. It should be noted that the aforementioned potential advantages are set forth for illustrative purposes only and should not be construed as limiting in any manner.

### BRIEF DESCRIPTION OF THE DRAWINGS

FIG. 1 illustrates a method for enabling repeat performance of a prior performed task within an application based on a current context of a mobile device, in accordance with one embodiment.

FIG. 2A illustrates a system for enabling repeat performance of a prior performed task within an application based on a current context of a mobile device, in accordance with one embodiment.

FIG. 2B illustrates a mobile device architecture including a recommendation application for enabling repeat performance of a prior performed task within an application based on a current context of the mobile device, in accordance with one embodiment.

FIG. 3 illustrates a communication flow including inputs and outputs of a recommendation application that enables repeat performance of a prior performed task within a user application, in accordance with another embodiment.

FIG. 4 illustrates a home screen of a mobile device presenting mobile UIs for causing repeat of prior performed tasks that are relevant to a current context of a mobile device, in accordance with another embodiment.

FIG. 5 illustrates a recommendation UI that provides details on one of the mobile UIs of FIG. 4, in accordance with another embodiment.

FIG. 6 illustrates a dynamic user profile, in accordance with another embodiment.

FIG. 7 illustrates a flow chart for monitoring usage of a user application to perform a task, in accordance with another embodiment.

FIG. 8 illustrates a communication flow including inputs and outputs of a recommendation application that enables repeat performance of a prior performed task within a user application associated with a web-based service, in accordance with yet another embodiment.

FIG. 9 illustrates a flow chart of a use-case for enabling repeat performance of a prior performed task within a user application based on a current context of a mobile device, in accordance with one embodiment.

FIG. 10 illustrates a flow chart of a use-case for enabling repeat performance of a prior performed task within a user application based on a current context of a mobile device, in accordance with one embodiment.

FIG. 11 illustrates a flow chart for enabling repeat performance of a prior performed task within a user application based on a current context of a mobile device, in accordance with one embodiment.

FIG. 12 is a diagram of a network architecture, in accordance with one embodiment.

FIG. 13 is a diagram of an exemplary system, in accordance with one embodiment.

### DETAILED DESCRIPTION

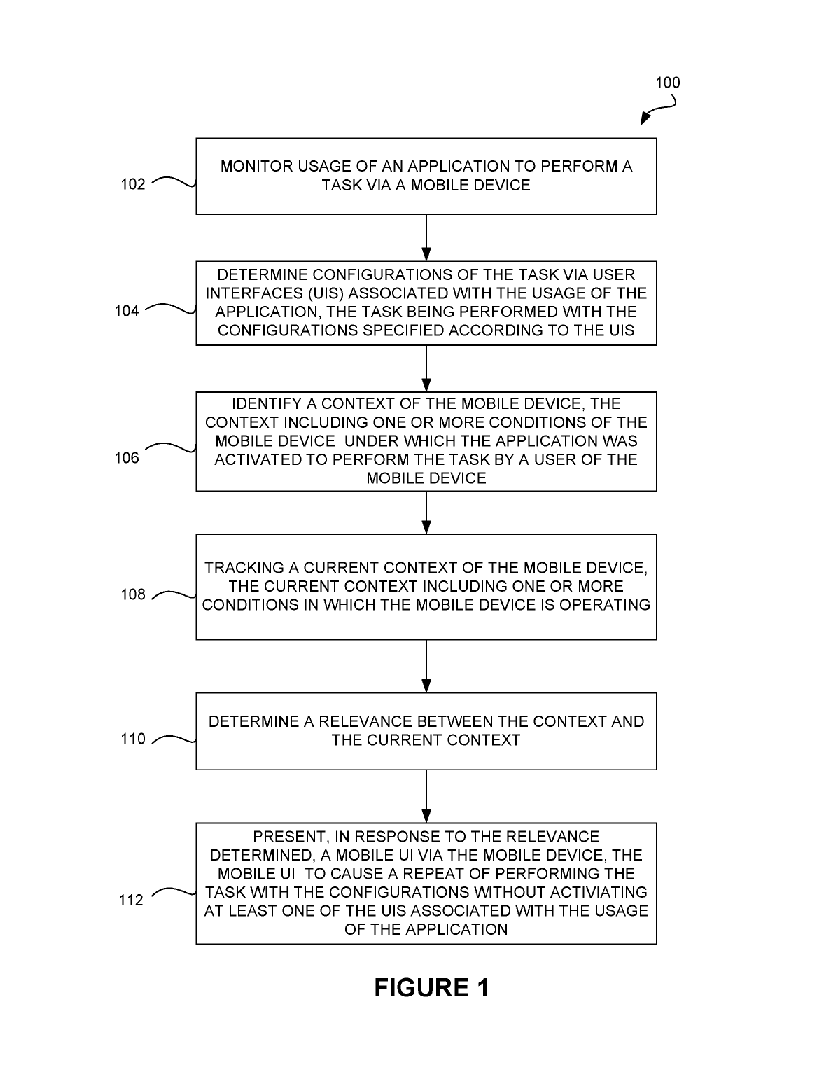

FIG. 1 illustrates a method 100 for enabling repeat performance of a prior performed task within an application based on a current context of a mobile device, in accordance with one embodiment. In one embodiment, the method 100 may be performed by the mobile device. For example, the method 100 may be performed by a recommendation application installed and executing on the mobile device, such as the recommendation described in further detail below with reference to the subsequent figures.

As shown in operation 102, usage of an application to perform a task via a mobile device is monitored. In the context of the present description, the application is separate from the recommendation application mentioned above. In one embodiment, the application may be a mobile application (e.g. third party application) or system application installed on the mobile device. In another embodiment, the application may be a web application located in the cloud remotely from the mobile device, where usage of the web application to perform the task via the mobile device is enabled using a network.

In some exemplary embodiments, the application may be a messaging application (e.g. email, short message service (SMS), etc.), a media player (e.g. for playing video and/or audio), a merchant store (e.g. for purchasing products and/or services), a transportation reservation application (e.g. for making transportation reservations), etc. Thus, usage of these applications to perform various tasks, such as sending a message, playing media, making a purchase, making a transportation reservation, etc., may be monitored.

Additionally, as shown in operation 104, configurations of the task via user interfaces (UIs) associated with the usage of the application are determined, the task being performed with the configurations specified according to the UIs. In particular, the user may specify the configurations for the task via the UIs associated with the usage of the application, and the task may be performed with those specified configurations. The configurations may be determined through the monitoring of the usage of the application described with respect to operation 102.

In one embodiment, the UIs associated with the usage of the application may be UIs of the application through which the user navigates to specify the configurations for the task, and further initiate performance of the task with the configurations. The configurations may be entirely dependent on the task itself, and may be input by the user through configurable options, settings, etc. included in the UIs to allow the user to customize operation of the task.

Just by way of example, when the application is a transportation reservation application and the task is reserving a car service, the configurations may include a pick-up location, a pick-up time, a drop-off location, a type of car being reserved, etc. As another example, when the application is a messaging application and the task is sending a message (e.g. SMS message), the configurations may include an identifier of a recipient of the message, etc. As yet another example, when the application is a media player and the task is playing video, the configurations may include selection of a particular video to play.

Further, as shown in operation 106, a context of the mobile device is identified, the context including one or more conditions of the mobile device under which the application was activated to perform the task by a user of the mobile device. Thus, the context of the mobile device may be identified at a same time that the application was activated to perform the task by the user of the mobile device, and may optionally be identified in conjunction with the monitoring of the usage of the application described with respect to operation 102.

As noted above, the context of the mobile device that is identified includes one or more conditions of the mobile device. These conditions may be of particular types that the method 100 has been preconfigured to identify. For example, the types of conditions required to be identified may include mobile device location, time of day, day of week, concurrent usage of additional applications, role of user using the mobile device, etc. With respect to these examples then, the one or more conditions of the mobile device under which the application was activated to perform the task may include a particular location of the mobile device when the application was activated to perform the task, a time of day and/or day of week indicated by the system of the mobile device when the application was activated to perform the task, additionally applications being used via the mobile device (e.g. by the user) when the application was activated to perform the task, etc.

As an option, once performance of the task, configurations for the task, and the associated context of the mobile device are identified in operations 102-106, the method 100 may store an indication of the task with the configurations and the context of the mobile device in a profile for the user. The profile may be dynamic in that the profile may be updated to store the aforementioned information upon identification thereof. Further, the profile may be located in local memory of the mobile device.

Still yet, as shown in operation 108, a current context of the mobile device is tracked, the current context including one or more conditions in which the mobile device is operating. In particular, the current context may be tracked to identify, at a point in time after the application has been used to perform the task as noted in operation 102, the one or more conditions in which the mobile device is operating. These conditions may be of the same type described above with respect to operation 106, and in particular the method 100 may be preconfigured to track these types of conditions in which the mobile device is operating. To this end, as a result of operation 108, one or more conditions in which the mobile device is operating may be identified.

In addition, as shown in operation 110, a relevance between the context and the current context is determined. Optionally, where the context has been stored in the profile of the user, the profile of the user may be accessed to identify the context in order to determine the relevance between the context and the current context of the mobile device. Of course, the context may be identified, or retrieved, from any storage location for the purpose of determining the relevance thereof to the current context of the mobile device.

It should be noted that the relevance may be determined using any desired algorithm or computer process capable of comparing the context and the current context to determine that a predefined degree of similarity exists between the context and the current context. For example, in one embodiment, determining the relevance between the context and the current context may include determining that the current context is within a predefined threshold difference from the context.

Moreover, as shown in operation 112, in response to the relevance determined, a mobile UI is presented via the mobile device, the mobile UI to cause a repeat of performing the task with the configurations without activating at least one of the UIs associated with the usage of the application. For example, the mobile UI maybe an icon which when selected by the user causes the repeat of performing the task with the configurations. Thus, the repeat performance of the task with the configurations can be initiated by the user through the mobile UI and thus without the user activating (e.g. opening, accessing, interacting with, etc.) at least one, or all, of the UIs associated with the usage of the application.

For example, the user may initially configure and initiate the task through usage of the UIs associated with the application (e.g. by opening, accessing, and interacting with the UIs). This usage may be monitored in operation 102. The mobile UI then, when presented in operation 112, may act as a shortcut to the task with the configurations, such that the user can initiate the task through the mobile UI instead of having to again use at least one, or all, of the UIs associated with the application.

In one embodiment, the mobile UI may be presented on a home screen (UI) of the mobile device. Of course, the mobile UI may be presented on any other screen (UI) that is different from the UIs associated with the usage of the application. Accordingly, the mobile UI may optionally be presented without activating any UI of the application (i.e. any UI included as part of the application), and in any case may allow the user to repeat the specific task without having to again navigate through the same UIs of the application associated with the previous performance of the task.

To this end, in some optional embodiments, one or more of the foregoing features of the aforementioned device and/or method may enable repeat performance of a prior performed task within an application based on a current context of the mobile device. In particular, as described above, a specific mobile UI to repeat the same prior performed task (without again going through the UIs of the application) may only be provided when relevant to a current context of the mobile device. This may ensure that the mobile UI specific to that task is presented at an appropriate time for the user. Further, by presenting the mobile UI to cause the same prior performed task to be repeated, the user may initiate repeat of the same prior performed task without having to again use the UIs of an application to configure and/or initiate the task. It should be noted that the aforementioned potential advantages are set forth for illustrative purposes only and should not be construed as limiting in any manner.

Furthermore, in some embodiments, the method 100 may be repeated for a plurality of different applications. For example, usage of an additional application to perform an additional task via the mobile device may be monitored (e.g. in the manner described above with respect to operation 102). Additionally, configurations of the additional task via additional user interfaces (UIs) associated with the usage of the additional application may be determined, the additional task being performed with the configurations specified according to the additional UIs (e.g. in the manner described above with respect to operation 104). Further, an additional context of the mobile device may be identified, the additional context including one or more conditions of the mobile device under which the additional application was activated to perform the additional task by the user of the mobile device (e.g. in the manner described above with respect to operation 106), and an additional relevance between the additional context and the current context may be determined (e.g. in the manner described above with respect to operation 108). Moreover, in response to the additional relevance determined, an additional mobile UI may be presented via the mobile device in combination with the mobile UI presented in operation 110, the additional mobile UI to cause a repeat of performing the additional task with the configurations of the additional task without activating at least one of the additional UIs associated with the usage of the additional application (e.g. in the manner described above with respect to operation 110).

More illustrative information will now be set forth regarding various optional architectures and uses in which the foregoing method 100 may or may not be implemented, per the desires of the user. For example, various embodiments will be described that may further enhance the aforementioned method 100 to enable repeat performance of a prior performed task within an application based on a current context of the mobile device.

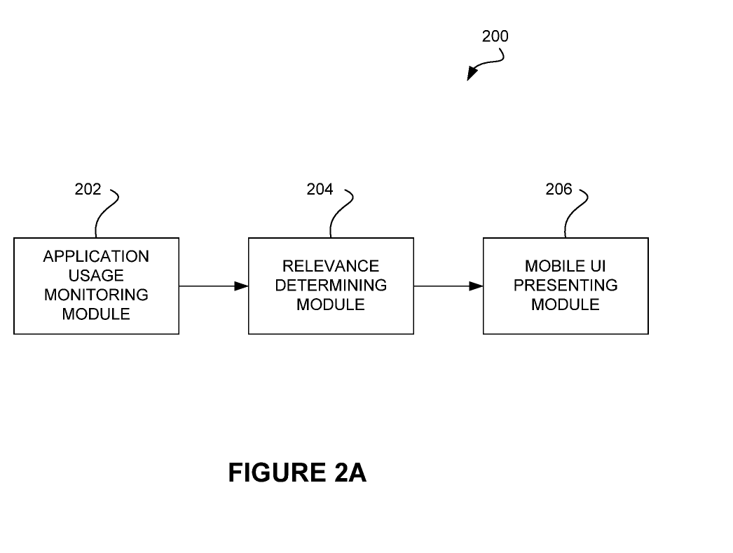

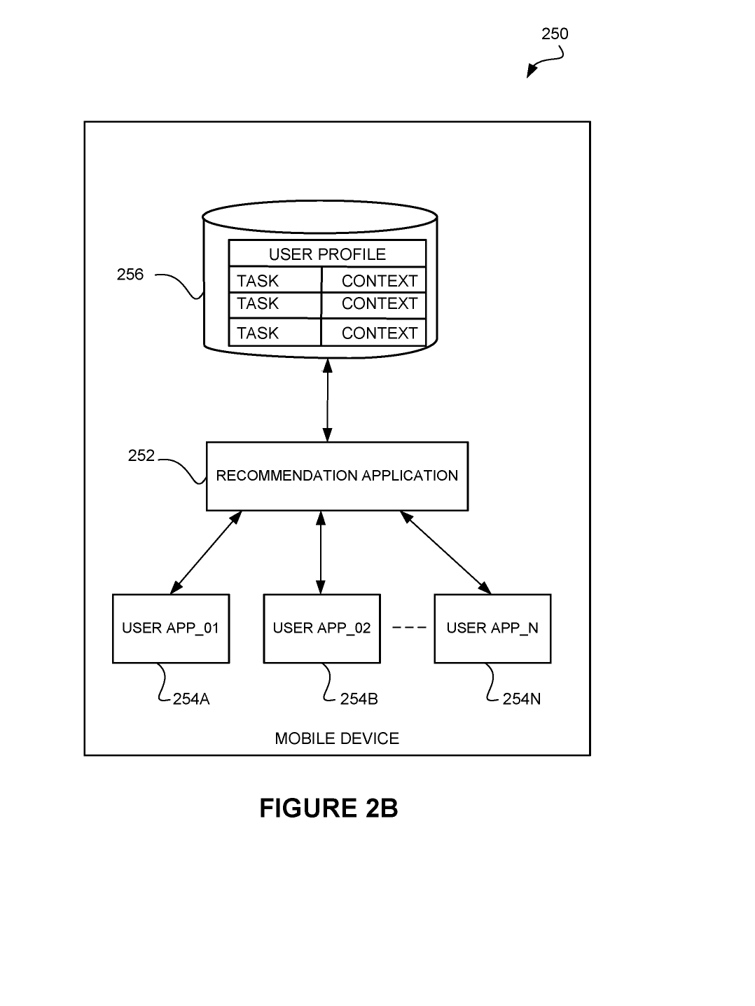

FIG. 2A illustrates a system 200 for enabling repeat performance of a prior performed task within an application based on a current context of a mobile device, in accordance with one embodiment. As an option, the system 200 may be implemented with one or more features of any one or more of the embodiments set forth in any previous and/or subsequent figure(s) and/or the description thereof. However, it is to be appreciated that the system 200 may be implemented in other suitable environments.

As shown, application usage monitoring means in the form of an application usage monitoring module 202 is provided for monitoring usage of an application to perform a task via a mobile device, for determining configurations of the task via user interfaces (UIs) associated with the usage of the application, the task being performed with the configurations specified according to the UIs, and for identifying a context of the mobile device, the context including one or more conditions of the mobile device under which the application was activated to perform the task by a user of the mobile device (e.g. see operations 102-106 of FIG. 1). In various embodiments, the application usage monitoring module 202 may include, but is not limited to at least one processor (to be described later) and any software controlling the same, and/or any other circuitry capable of the aforementioned functionality.

Also included is relevance determining means in the form of a relevance determining module 204 in communication with the application usage monitoring module 202 for tracking a current context of the mobile device, the current context including one or more conditions in which the mobile device is operating, and for determining a relevance between the context and the current context (e.g. see operations 108-110 of FIG. 1). In various embodiments, the relevance determining module 204 may include, but is not limited to at least one processor (to be described later) and any software controlling the same, and/or any other circuitry capable of the aforementioned functionality.

Further included is mobile UI presenting means in the form of a mobile UI presenting module 206 in communication with the relevance determining module 204 for presenting, in response to the relevance determined, a mobile UI via the mobile device, the mobile UI to cause a repeat of performing the task with the configurations without activating at least one of the UIs associated with the usage of the application (e.g. see operation 112 of FIG. 1). In various embodiments, the relevance determining module 204 may include, but is not limited to at least one processor (to be described later) and any software controlling the same, and/or any other circuitry capable of the aforementioned functionality.

More information will now be set forth regarding one possible example of various input/output of the different components described hereinabove.

FIG. 2B illustrates a mobile device 250 architecture having an intelligent offline content manager for managing offline accessibility of online content, in accordance with one embodiment. As an option, the mobile device 250 may be implemented in the context of any one or more of the embodiments set forth in any previous and/or subsequent figure(s) and/or description thereof.

In the embodiment shown, the mobile device 250 includes means in the form of components of the mobile device, which are described below. In various embodiments, the components may include, but are not limited to at least one processor (to be described later) and any software controlling the same, memory, and/or any other circuitry capable of the functionality described herein.

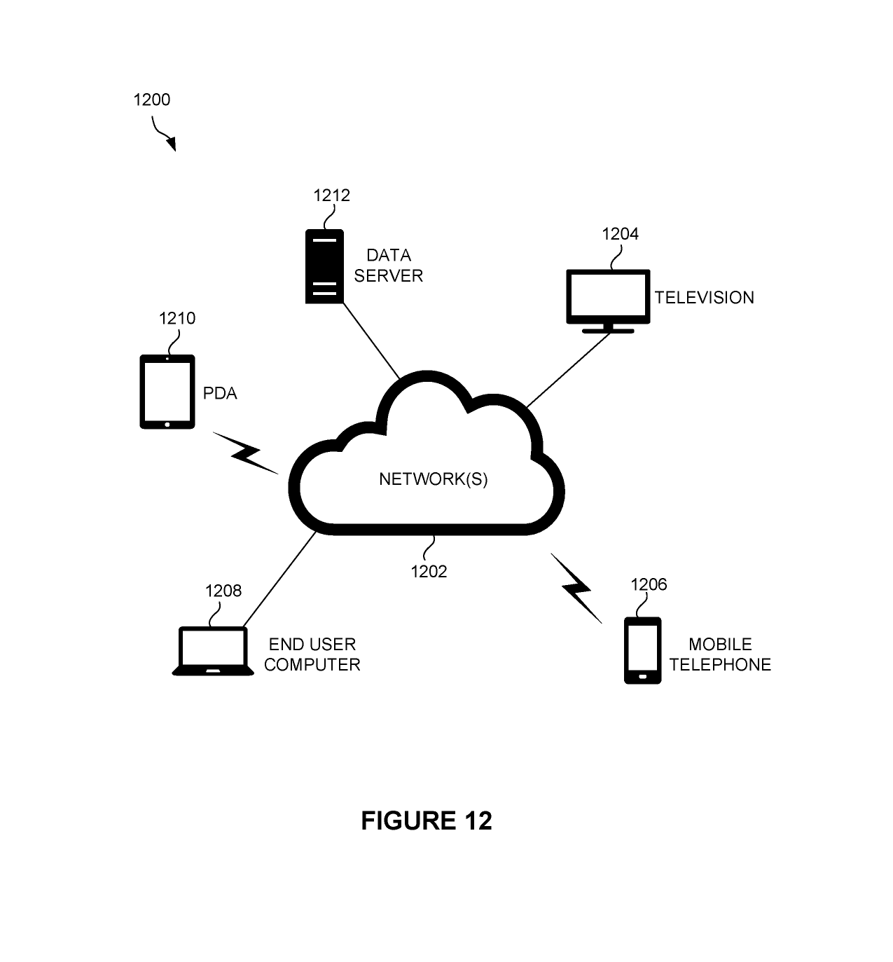

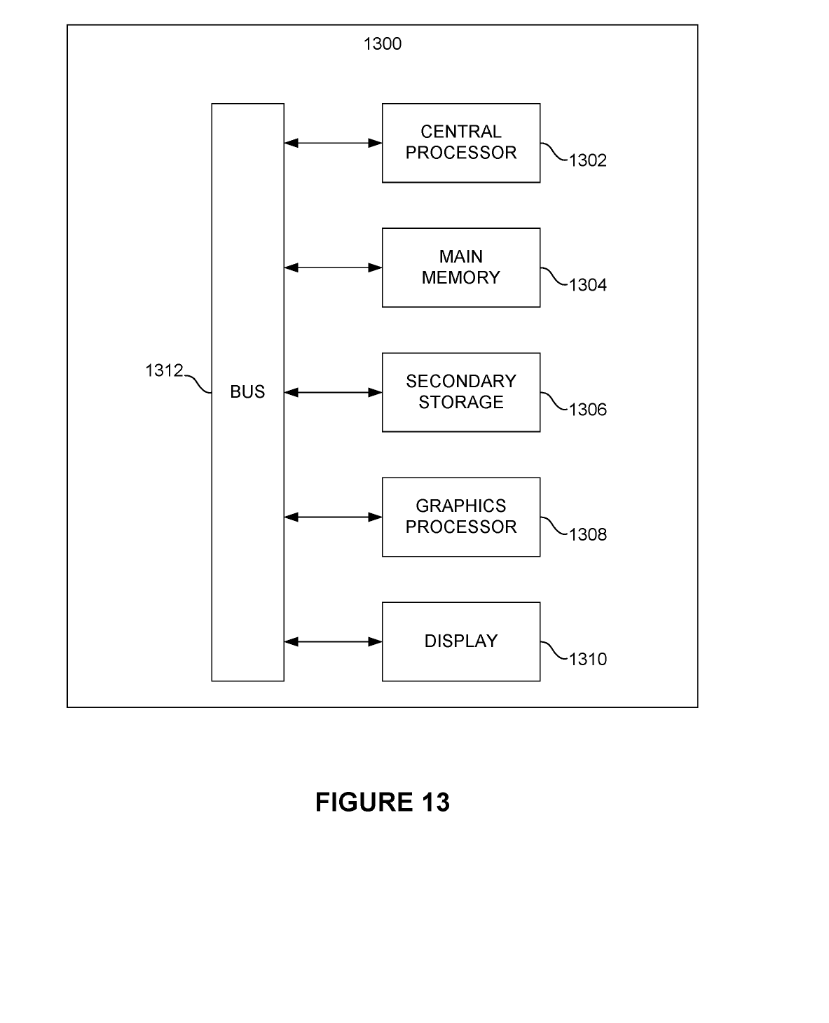

The mobile device 250 may be any of the user devices described below with reference to FIGS. 12 and 13. As shown, the components of the mobile device 250 include a recommendation application 252. The recommendation application 252 is a software program that executes on the mobile device 250 to perform the method 100 of FIG. 1. For example, the recommendation application 252 may include the modules described above with respect to FIG. 2A. The mobile device 250 may be configured to execute the recommendation application 252 automatically upon the mobile device powering up, or the mobile device 250 may be configured to execute the recommendation application 252 upon command by the user of the mobile device 250.

The components of the mobile device 250 further include user applications 254A-N, each of which are capable of being used by the user of the mobile device 250 to perform a task as described above with respect to the method 100 of FIG. 1. For example, the user applications 254A-N each include UIs through which the user can specify configurations for the task and can initiate performance of the task with the specified configurations. In response to the initiation of the task through a UI of one of the user applications 254A-N, the user application 254A-N may then perform the task in accordance with the specified configurations.

It should be noted that while the user applications 254A-N are shown in the present embodiment as being components of the mobile device 250, other embodiments are contemplated in which one or more of the user applications 254A-N may be installed on, and executed by, a cloud computing environment (e.g. on a server located remotely from the mobile device 250). In an embodiment where one or more of the user applications 254A-N are executing within the cloud computing environment, the mobile device 250 may include components that are interfaces (e.g. UIs, APIs, web interfaces, etc.) to those remotely located user applications 254A-N.

As further shown, the components of the mobile device 250 include a repository 256 that stores a user profile. The repository 256 can be a database, text file, or any other location in memory capable of storing structured data representing the user profile. As shown, the user profile indicates particular tasks performed by the user applications 254A-N, and may include the configurations specified for those tasks by the user. As also shown, for each indicated task, the user profile stores a corresponding context of the mobile device 250 under which the mobile device was activated to perform the task.

To this end, the user profile may store a history of prior tasks initiated by the user using the user applications 254A-N, along with the corresponding context of the mobile device 250. The recommendation application 252 may be configured to monitor usage of the user applications 254A-N by the user via the mobile device 250 (i.e. in order to identify the tasks performed by those user applications 254A-N and the user specified configurations of those tasks), and may further be configured to track a context of the mobile device 250 (i.e. in order to identify the particular context under which each of the tasks was performed). The recommendation application 252 may then store the identified tasks with corresponding configurations and corresponding mobile device context in the user profile.

In another embodiment, the user profile may also store a history of prior tasks initiated by other users, potentially through other mobile devices (not shown), particularly when one or more of the user applications 254A-N are executing within the cloud computing environment mentioned above. In this embodiment, the other mobile devices maybe configured in the same manner as shown in the present system 250 and thus may operate in the same manner as disclosed herein. The other mobile devices may then share with the mobile device 250 of the present description (via a network) the content of their user profiles (i.e. the history of prior tasks initiated by the other users).

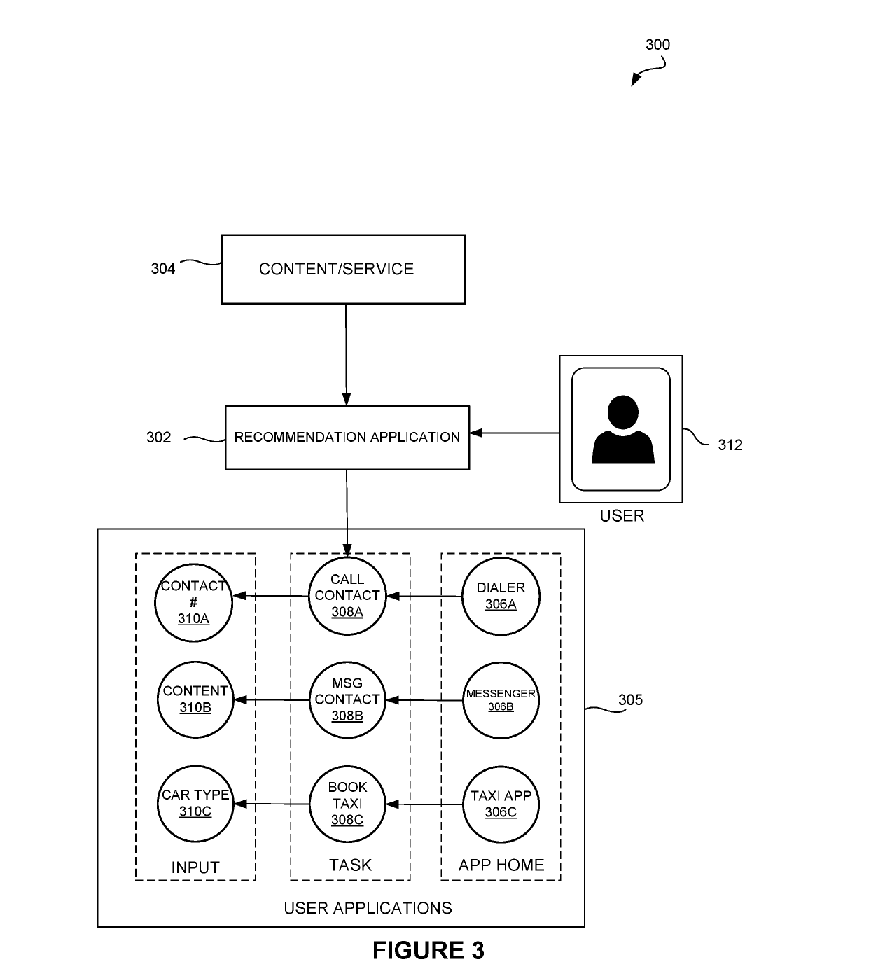

FIG. 3 illustrates a communication flow 300 including inputs and outputs of a recommendation application that enables repeat performance of a prior performed task within a user application, in accordance with another embodiment. As an option, the communication flow 300 may be implemented in the context of any one or more of the embodiments set forth in any previous and/or subsequent figure(s) and/or description thereof.

As shown, a recommendation application 302 makes content and services 304 available to a user 312 through user applications 305. The content may be web content such as video, news, music, etc. and/or content stored locally by the mobile device of the user such as contact information. Additionally, the services may be a web service such as travel reservation service and/or a service capable of being provided locally by the mobile device of the user. Further, the user applications 305 in the examples shown include a phone call application, a messenger application, and a car service application.

The recommendation application 302 allows the user 312 through a mobile device of the user to repeat a specific task within those user applications 305 in order to access the content and services 304 as described above with reference to the previous FIGS. 1-2. The recommendation application 302 determines tasks 308A-C with specific configurations that have previously been performed through the user applications 305 and that are relevant to a current context of the mobile device of the user 312, for the purpose of recommending those tasks 308A-C to the user 312. The recommendation application 302 then presents, for each of the tasks 308A-C, a mobile UI to cause a repeat of performing the task 308A-C. The mobile UI is different from the UIs otherwise associated with usage of the user applications 305.

In the specific examples shown, the recommendation application 302 determines, based on a current context of the mobile device (e.g. time of day, etc.), to recommend to the user 312 a first task 308A of a first user application of the user applications 305, where the first task 308A is to make a telephone call to a particular contact. Just by way of example, the recommendation application 302 may determine that the user 312 regularly performs the first task 308A within a particular time period on a particular day of the week. Thus, on that particular day of the week and during the particular time period, the recommendation application 302 may recommend to the user 312 the first task 308A.

The first task 308A is recommended by being presented by the recommendation application 302 to the user 312 via a first mobile UI. The first mobile UI may be presented on a home screen of the mobile UI, in one embodiment. When the user 312 selects first mobile UI presented by the recommendation application 302 via the mobile device, the first task 308A is automatically initiated within the first user application.

In the specific embodiment shown, initiating the first task 308A within the first user application includes allowing the user 312 to provide first input 310A, namely selection of a phone number of the contact stored by the mobile device and required for executing the first task 308A. Once the first input 310A is provided, the first task 308A may be performed by the mobile device through the first user application. Of course, as another option the first task 308A may be automatically initiated without requiring any further input by the user 312, such that upon selection of the first mobile UI by the user 312 the mobile device may make the telephone call to the particular contact. In any case, use of the first mobile UI by the user 312 to perform the first task 308A allows the user 312 to bypass navigation through the first user application, including the home UI 306A of the first user application, to initiate the first task 308A.

In another specific example shown, the recommendation application 302 determines, based on a current context of the mobile device (e.g. time of day, etc.), to recommend to the user 312 a second task 308B of a second user application of the user applications 305, where the second task 308B is to send a message to a particular contact. Just by way of example, the recommendation application 302 may determine that the user 312 regularly performs the second task 308B within a particular time period on a particular day of the week. Thus, on that particular day of the week and during the particular time period, the recommendation application 302 may recommend to the user 312 the second task 308B.

The second task 308B is recommended by being presented by the recommendation application 302 to the user 312 via a second mobile UI. The second mobile UI may be presented on the home screen of the mobile UI (e.g. with the first mobile UI), in one embodiment. When the user 312 selects second mobile UI presented by the recommendation application 302 via the mobile device, the second task 308B is automatically initiated within the second user application.

In the specific embodiment shown, initiating the second task 308B within the second user application includes allowing the user 312 to provide second input 310B, namely content (e.g. text) required for executing the second task 308B. Once the second input 310B is provided, the second task 308B may be performed by the mobile device through the second user application. Of course, as another option the second task 308B may be automatically initiated without requiring any further input by the user 312, such that upon selection of the second mobile UI by the user 312 the mobile device may send to the particular contact the message having content specified through predetermined configurations for the second task 308B. In any case, use of the second mobile UI by the user 312 to perform the second task 308B allows the user 312 to bypass navigation through the second user application, including the home UI 306B of the second user application, to initiate the second task 308B.

In yet another specific example shown, the recommendation application 302 determines, based on a current context of the mobile device (e.g. time of day, etc.), to recommend to the user 312 a third task 308C of a third user application of the user applications 305, where the third task 308C is to reserve a car service. Just by way of example, the recommendation application 302 may determine that the user 312 regularly performs the third task 308C within a particular time period on a particular day of the week. Thus, on that particular day of the week and during the particular time period, the recommendation application 302 may recommend to the user 312 the third task 308C.

The third task 308C is recommended by being presented by the recommendation application 302 to the user 312 via a third mobile UI. The third mobile UI may be presented on the home screen of the mobile UI (e.g. with the first and/or second mobile UIs), in one embodiment. When the user 312 selects third mobile UI presented by the recommendation application 302 via the mobile device, the third task 308C is automatically initiated within the third user application.

In the specific embodiment shown, initiating the third task 308C within the third user application includes allowing the user 312 to provide third input 310C, namely a desired car type required for executing the third task 308C. Once the third input 310C is provided, the third task 308C may be performed by the mobile device through the third user application. Of course, as another option the third task 308C may be automatically initiated without requiring any further input by the user 312, such that upon selection of the third mobile UI by the user 312 the mobile device may make the reservation for the car service with a car type specified through predetermined configurations for the third task 308C. In any case, use of the third mobile UI by the user 312 to perform the third task 308C allows the user 312 to bypass navigation through the third user application, including the home UI 306C of the third user application, to initiate the third task 308C.

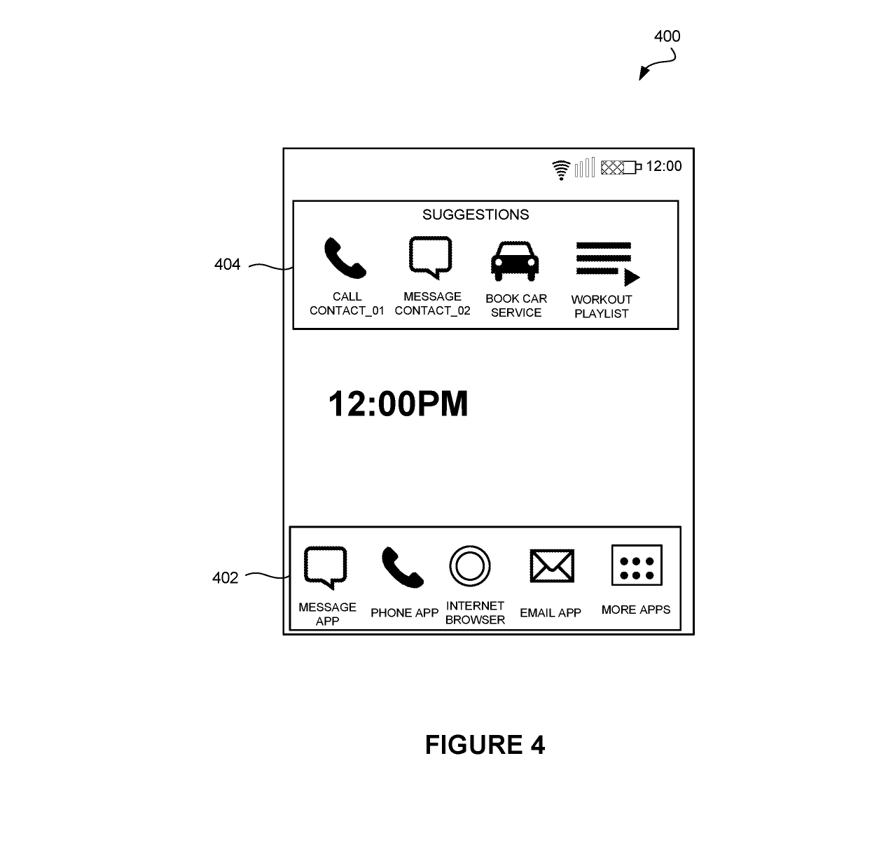

FIG. 4 illustrates a home screen 400 of a mobile device presenting mobile UIs for causing repeat of prior performed tasks that are relevant to a current context of a mobile device, in accordance with another embodiment. As an option, the home screen 400 may be implemented in the context of any one or more of the embodiments set forth in any previous and/or subsequent figure(s) and/or description thereof. For example, the home screen 400 may present the mobile UIs described above with respect to FIG. 3.

As shown, the home screen 400 of the mobile device presents representative UIs 402, or selectable icons, for a plurality of user applications accessible via the mobile device. The mobile device may be installed on (and thus executable on) the user device, or may be web applications executable in the cloud via initiation by the user device. In the examples shown, the representative UIs 402 are for a messaging application, a phone application, a internet browser, an email application, and a UI to access additional (not shown on the home screen 400) representative UIs for other user applications.

The user of the mobile device may access the user applications for use thereof through the representative UIs 402. In particular, when a user of the mobile device selects one of the representative UIs 402, the mobile device presents to the user a home page UI of the represented user application. The user may then navigate from the home page UI to a task-specific UI of the represented user application for configuring and initiating a particular task. This navigation may be similar to that described above with respect to FIG. 3 was being bypassed when the user accesses the task via the mobile UI presented through the recommendation application.

As also shown, the home screen 400 of the mobile device presents mobile UIs 404 corresponding to a plurality of tasks (with predefined configurations) being recommended by a recommendation application based on a current context of the mobile device. When the user of the mobile device selects one of the mobile UIs 404, the mobile device initiates the corresponding task through the associated user application. The mobile UIs 404 are thus different from the representative UIs 402 for the user applications, and may be presented by the recommendation application on the home screen 400 of the mobile device. In the examples shown, the mobile UIs 404 can cause tasks to be initiated, such as calling a particular contact, sending a message to a particular contact, reserving a car service, and playing a music play list.

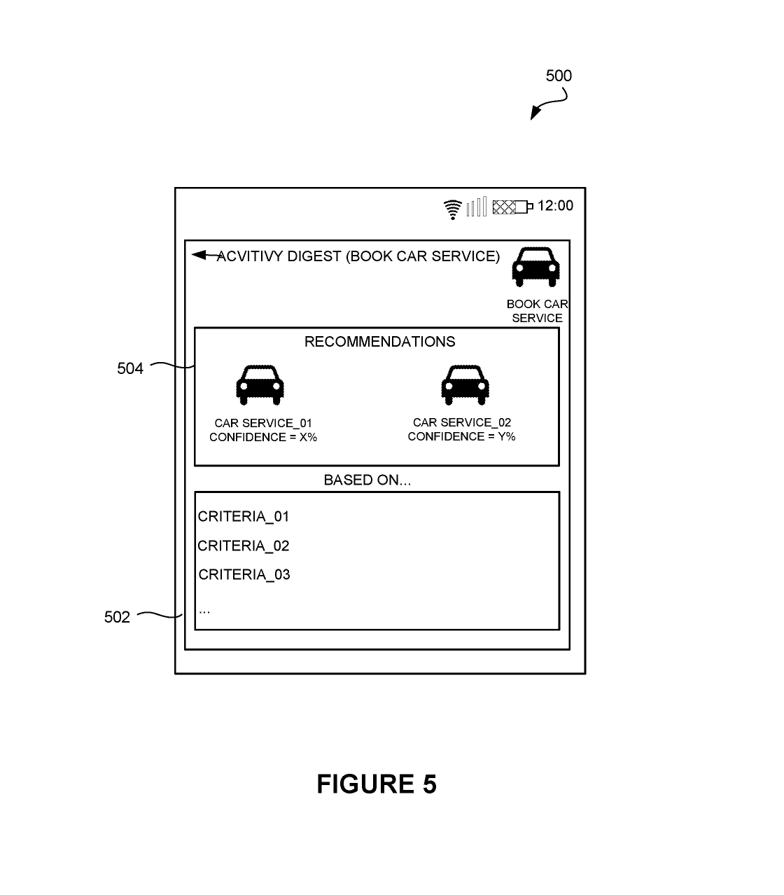

FIG. 5 illustrates a recommendation UI 500 that provides details on one of the mobile UIs 404 of FIG. 4, in accordance with another embodiment. The recommendation UI 500 may be presented via the mobile device when the user of the mobile device right-clicks one of the mobile UIs 404 to display a drop-down menu and selects an item from the drop-down menu to view the recommendation UI 500. The recommendation UI 500 provides information on the task represented by the user-selected mobile UI 404.

The information may include the conditions under which the mobile device is operating that prompted the mobile UI 404 to be presented. The information may also include set configurations for the task. Further, the information may include alternative configurations for the task that the user may select.

In the example shown, when the user of the mobile device right-clicks the mobile UI 404 of FIG. 4 that represents the particular task of making a car service reservation, and selects from a resulting drop-down list an item to view the recommendation UI 500 for the particular task, then the recommendation UI 500 is presented via the mobile device. This recommendation UI 500 provides information on the task of making a car service reservation, indicating the conditions 502 under which the mobile device is operating that prompted the mobile UI 404 to be presented.

The information provided by the recommendation UI 500 also indicates configurations 504 for the task. These configurations include a set configuration for the task (i.e. which in the present example shown is a first car service, or service provider, being recommended through the mobile UI 404), as well as an alternative configuration for the task (i.e. which in the present example shown is a second car service, or service provider) that the user can select through the recommendation UI 500 as an alternative to the set configuration. The information indicating the configurations 504 may show a confidence rating (i.e. shown as X %, Y %) for the set and alternative configurations, where the confidence ratings are based on an amount that the respective configurations have been used in the past for the task by the user (and optionally other users) and/or an availability of web services required by the user application to perform the task. The set configuration may be the one with the higher confidence rating, whereas the alternative configuration may be the one with the lower confidence rating.

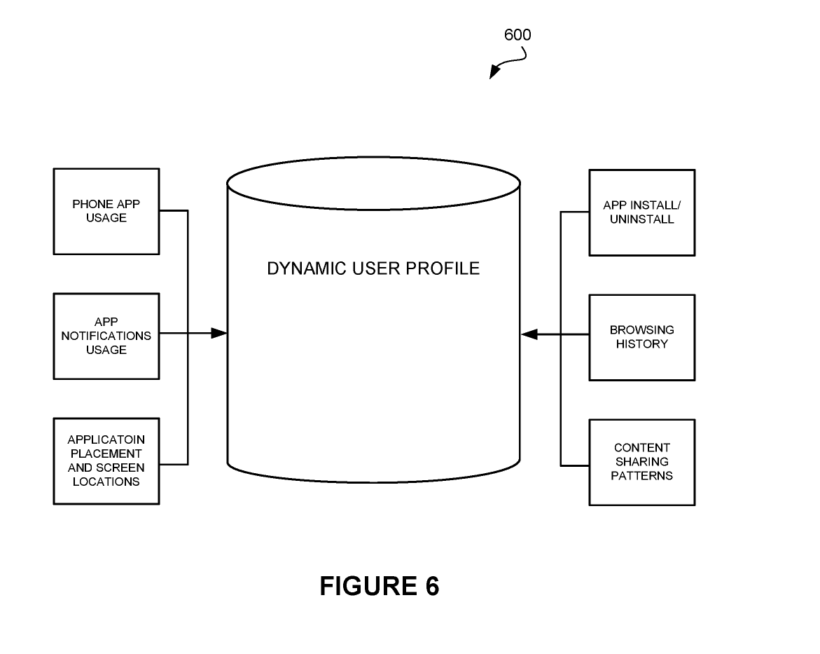

FIG. 6 illustrates a dynamic user profile 600, in accordance with another embodiment. As an option, the dynamic user profile 600 may be implemented in the context of any one or more of the embodiments set forth in any previous and/or subsequent figure(s) and/or description thereof. For example, the dynamic user profile 600 may be generated, or otherwise received by, the recommendation application.

As shown, the dynamic user profile 600 is generated from various source data, which may be identified from monitoring multiple different data sources via the mobile device. Thus, entries in the dynamic user profile 600, such as shown in item 256 of FIG. 2B, may be derived from the source data. The dynamic user profile 600 may be continuously or periodically updated based on new data from those different sources. Further, while the source data is described with reference to the user for which the dynamic user profile 600 is generated, other embodiments are contemplated in which the source data may also be gathered based on activities of other users.

In one embodiment, the source data may include phone application usage. For example, the dynamic user profile 600 may store an indication of tasks that the phone application was previously activated by the user to perform, as well as the configurations for those tasks set by the user, and further a context of the mobile device under which the tasks were performed. These tasks may include phone calls to particular contacts, for example.

In another embodiment, the source data may include content sharing patterns. For example, the dynamic user profile 600 may store an indication of tasks that content sharing applications (e.g. social media applications) were previously activated by the user to perform, as well as the configurations for those tasks set by the user, and further a context of the mobile device under which the tasks were performed. These tasks may include sharing (e.g. posting, transmitting, etc.) content for access by certain user groups (e.g. through Facebook, etc.) or for access by certain users (e.g. through SMS, WeChat, etc.), for example.

In yet another embodiment, the source data may include a browsing history. For example, the dynamic user profile 600 may store an indication of tasks that an Internet browser was previously activated by the user to perform, as well as the configurations for those tasks set by the user, and further a context of the mobile device under which the tasks were performed. These tasks may include accessing certain web pages, for example.

In another embodiment, the source data includes application notification usage, application install/uninstall activity, and application placement and screen locations. For example, the dynamic user profile 600 may weigh the aforementioned tasks differently based on this source data. The weights may then be used to prioritize which tasks are recommended to user through the recommendation application. Just by way of example, tasks performed through user applications having a representative UI on a home screen of the mobile device, as described with respect to FIG. 4, may be given a greater weight than other user applications without representative UI on the home screen of the mobile device. As another example, tasks for user applications that have been uninstalled from the mobile device may be removed from the dynamic user profile 600. As yet another example, when the user configures the mobile device to provide notifications of certain activity within certain user applications (e.g. incoming messages, etc.), then tasks of those certain user applications may be given more weight than tasks of other applications.

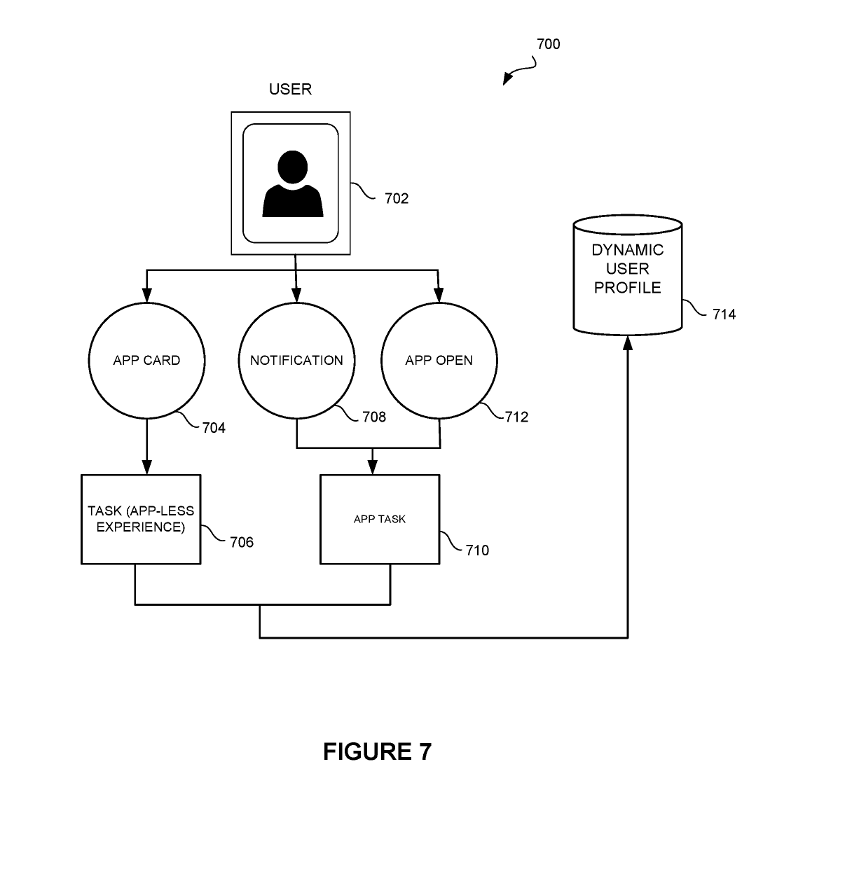

FIG. 7 illustrates a flow chart 700 for monitoring usage of a user application to perform a task, in accordance with another embodiment. As an option, the flow chart 700 may be implemented in the context of any one or more of the embodiments set forth in any previous and/or subsequent figure(s) and/or description thereof. For example, the flow chart 700 may be implemented for the purpose of storing information in the dynamic user profile 600 in FIG. 6.

As shown, a user 702 of a mobile device can access an application card 704 presented on the mobile device to perform a task 706 of a user application. The application card 704 may be a third party application UI that statically represents the task 706 for selection by the user to activate the user application to present a UI of the application for use by the user in configuring and initiating the task 706. For example, the application card 704 may be presented on the home screen of the mobile device or any other screen of the mobile device as configured by the user.

In another embodiment, the user 702 can perform a task 710 through a notification 708 generated and presented by the mobile device. For example, the mobile device may be configured by the user to generate and present the notification for certain activity of a user application, such as a message received through a messaging application. The user 702 can select the notification to open a UI of the user application that allows the user to configure and initiate the task 710.

In yet another embodiment, the user 702 can perform the task 710 through a home page UI 712 of the user application. For example, the user 702 may select a representative UI for the user application to open the home page UI 712 of the user application. The user may then navigate through UIs of the user application to open the above described UI of the user application that allows the user to configure and initiate the task 710.

When a task 706, 710 is performed, information indicative of the task is stored in the dynamic user profile 714. This information may include an indication of the task, the configurations for the task, and a context of the mobile device under which the task was performed. As an option, an indication of which UI 704, 708, 712 was used to initiate the task may also be indicated in the dynamic user profile 714, such as for determining a weight of the task for prioritization purposes.

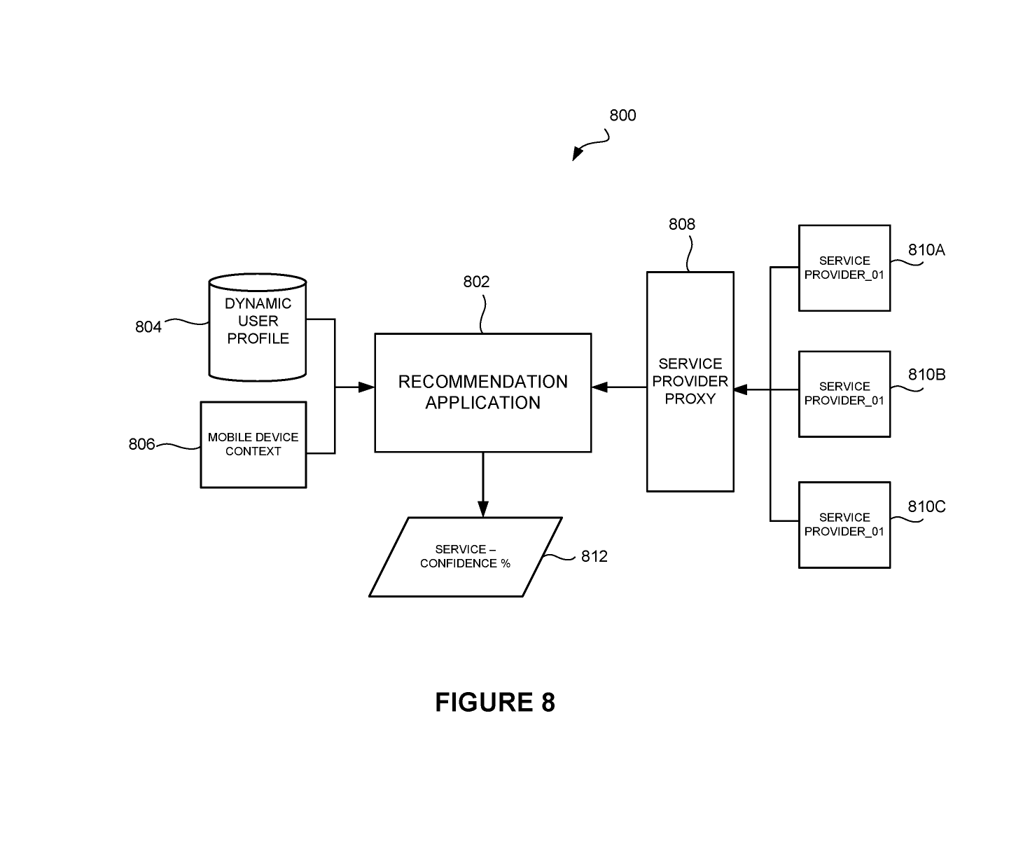

FIG. 8 illustrates a communication flow 800 including inputs and outputs of a recommendation application that enables repeat performance of a prior performed task within a user application associated with a web-based service, in accordance with yet another embodiment. As an option, the communication flow 800 may be implemented in the context of any one or more of the embodiments set forth in any previous and/or subsequent figure(s) and/or description thereof. For example, the communication flow 800 may be implemented across a mobile device and cloud computing environment.

As shown, a recommendation application 802 executing on a mobile device receives input from the mobile device in the form of data from a dynamic user profile 804 as well as a current context of the mobile device. In one embodiment, the recommendation application 802 may search the dynamic user profile 804 using the current context of the mobile device to determine whether any task indicated within the dynamic user profile 804 is relevant to the current context of the mobile device.

The recommendation application 802 also receives input from a cloud computing environment, and in particular from a service provider proxy 808 indicating availability of various services provided by various service providers 810A-C via the cloud computing environment and through which the determined task can be performed. In one embodiment, for tasks determined by the recommendation application 802 to be relevant to the current context of the mobile device, the recommendation application 802 may query the service provider proxy 808 for availability of the services across the different service providers 810A-C through which the task can be performed.

Based on the indication of service availability received by the recommendation application 802 from the service provider proxy 808, the recommendation application 802 determines a confidence rating 812 for the different services through which the task can be performed. The confidence rating can also be determined from other information indicated by the dynamic user profile 804, such as a degree of relevance of the task to the current context of the mobile device, a frequency with which the user has used the different services to perform the task, and/or features of the service (e.g. timeliness to perform the task, cost of performing the task, etc.).

The recommendation application 802 can then recommend the task to the user using a mobile UI through which the user can initiate performance of the task. The mobile UI may be configured to initiate performance of the task through the user application using the service with the highest confidence level. As described above with reference to FIG. 5, the user may also access through the mobile UI information on the other available services with the lower confidence ratings.

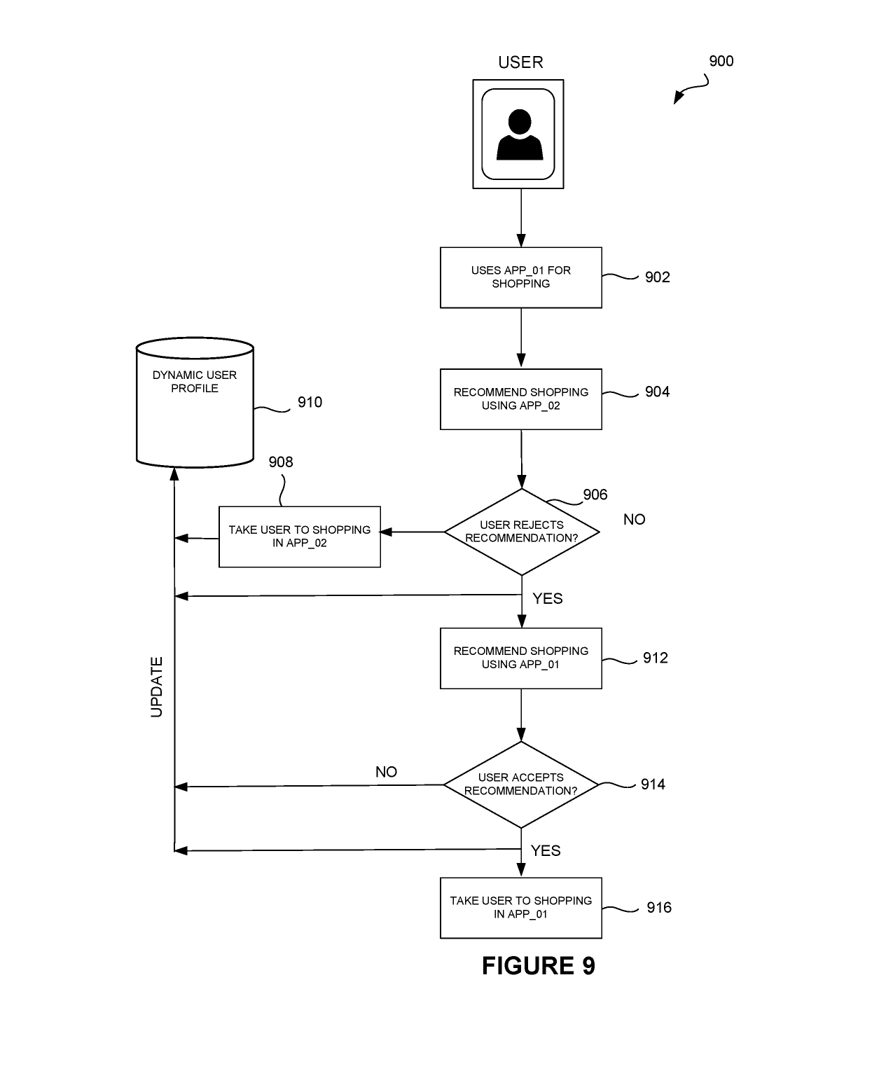

FIG. 9 illustrates a flow chart 900 of a use-case for enabling repeat performance of a prior performed task within a user application based on a current context of a mobile device, in accordance with one embodiment. As an option, the flow chart 900 may be implemented in the context of any one or more of the embodiments set forth in any previous and/or subsequent figure(s) and/or description thereof. For example, the flow chart 900 may be implemented by the recommendation application described above.

As shown in operation 902, a user uses a first user application (APP_01) for a task (i.e. shopping). A recommendation application then recommends at a later point in time, through a mobile UI, a second user application (APP_02) for shopping, as shown in operation 904. It is determined in decision 906 whether the user rejects the recommendation made in operation 904. If it is determined that the user does not reject the recommendation (i.e. the user accepts, or selects, the recommendation to perform the shopping task), the user is taken to a shopping task UI in the second user application, as shown in operation 908. Additionally, the dynamic user profile is updated as shown in 910 to reflect the acceptance of the recommendation (e.g. increase the weight of the second user application for performing the task).

If, however, it is determined that the user does reject the recommendation (i.e. the user does not accept, or select, the recommendation over a certain period of time, or the user selects an alternative configuration for the task in order use the first user application), the dynamic user profile is updated as shown in 910. In particular, the dynamic user profile may be updated to increase the weight given to the first user application. Further, when it is determined that the user does reject the recommendation, the recommendation application, at a later point in time and based on the updated dynamic user profile, then recommends the first user application for shopping, as shown in operation 912.

Further, as shown in decision 914, it is determined whether the user accepts the recommendation made in operation 912. If it is determined that the user accepts the recommendation, the user is taken to a shopping task UI in the first user application, as shown in operation 908. Additionally, the dynamic user profile is updated as shown in 910 to reflect the acceptance of the recommendation (e.g. increase the weight of the first user application for performing the task). However, if it is determined that the user does not accept the recommendation, the dynamic user profile is updated as shown in 910 (e.g. to decrease the weight given to the first user application).

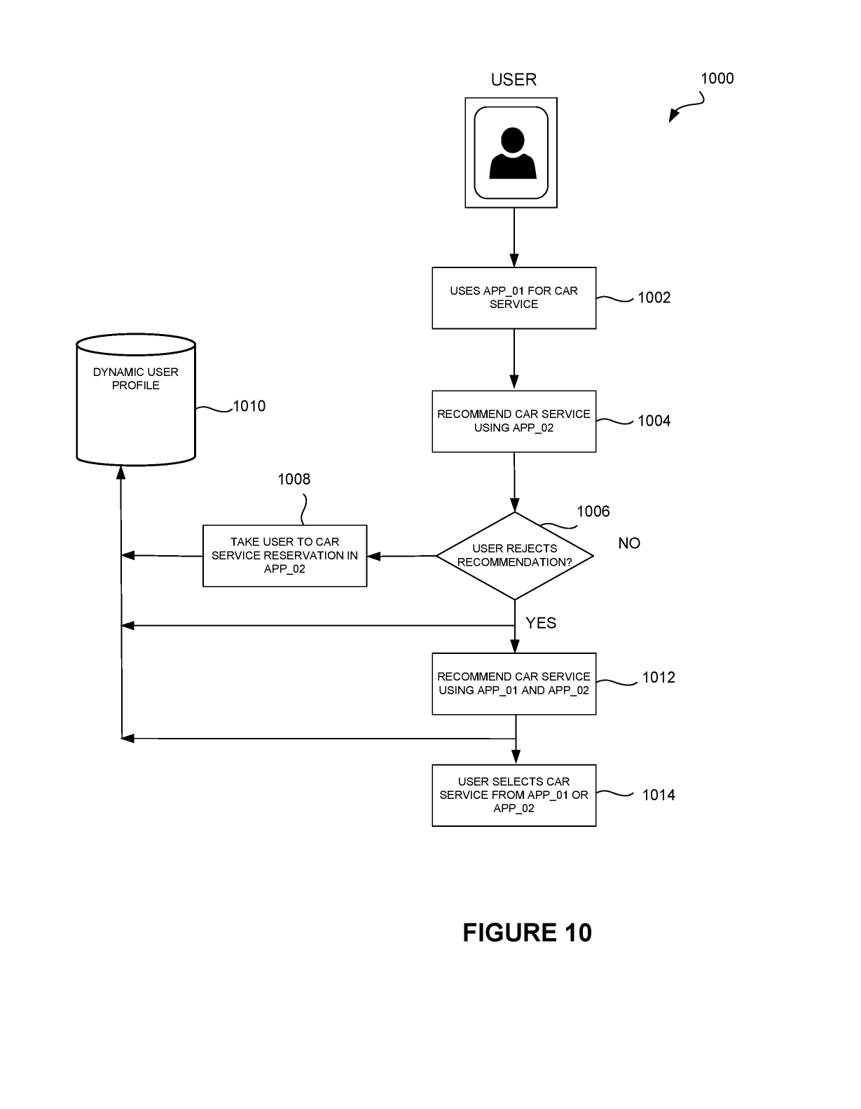

FIG. 10 illustrates a flow chart 1000 of a use-case for enabling repeat performance of a prior performed task within a user application based on a current context of a mobile device, in accordance with one embodiment. As an option, the flow chart 1000 may be implemented in the context of any one or more of the embodiments set forth in any previous and/or subsequent figure(s) and/or description thereof. For example, the flow chart 1000 may be implemented by the recommendation application described above.

As shown in operation 1002, a user uses a first user application (APP_01) for a task (i.e. car service reservation). A recommendation application then recommends at a later point in time, through a mobile UI, a second user application (APP_02) for making a car service reservation, as shown in operation 1004. It is determined in decision 1006 whether the user rejects the recommendation made in operation 1004. If it is determined that the user does not reject the recommendation (i.e. the user accepts, or selects, the recommendation to make the car service reservation), the user is taken to a car service reservation UI in the second user application, as shown in operation 1008. Additionally, the dynamic user profile is updated as shown in 910 to reflect the acceptance of the recommendation (e.g. increase the weight of the second user application for performing the task).

If, however, it is determined that the user does reject the recommendation (i.e. the user does not accept, or select, the recommendation over a certain period of time, or the user selects an alternative configuration for the task in order use the first user application), the dynamic user profile is updated as shown in 1010. In particular, the dynamic user profile may be updated to increase the weight given to the first user application. Further, when it is determined that the user does reject the recommendation, the recommendation application, at a later point in time and based on the updated dynamic user profile, then recommends the first user application and the second user application for making a car service reservation, as shown in operation 1012. This may occur when the confidence rating for both user applications are equal. For example, operation 1012 may be accomplished by presenting two separate mobile UIs, one for each respective user application.

Further, as shown in operation 1014, the user selects one of the recommendations presented in operation 1012. In response, the user is taken to a car service reservation task UI in the selected user application. The dynamic user profile is then updated as shown in 1010 to reflect the user selection.

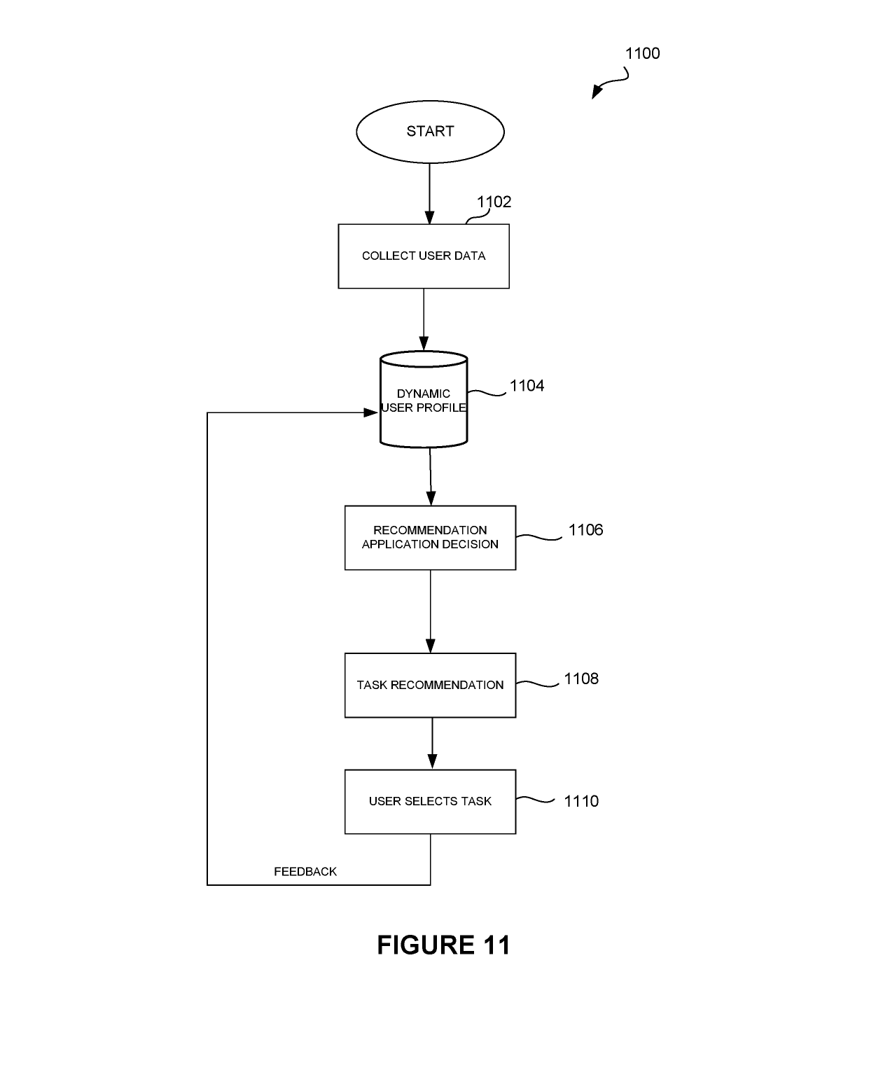

FIG. 11 illustrates a flow chart 1100 for enabling repeat performance of a prior performed task within a user application based on a current context of a mobile device, in accordance with one embodiment. As an option, the flow chart 1100 may be implemented in the context of any one or more of the embodiments set forth in any previous and/or subsequent figure(s) and/or description thereof. For example, the flow chart 1100 may be implemented by the recommendation application described above.

As shown in operation 1102, user data is collected, such as application usage data. The user data is then stored in a dynamic user profile, as shown in operation 1104. In particular, tasks performed through usage of applications are stored in the dynamic user profile, in association with the configurations of those tasks and the context of the mobile device under which those tasks were performed.

Additionally, as shown in operation 1106, a recommendation decision is made using the dynamic user profile. The recommendation decision includes determining which, if any, task in the dynamic user profile is relevant to a current context of the mobile device. Each task identified from the recommendation decision is then recommended to a user of the mobile device, as shown in operation 1108. Specifically, each task is recommended as a selectable mobile UI presented via the mobile device. When the user selects one of the mobile UIs, as shown in operation 1110, the mobile device repeats the task represented by the selected mobile UI in accordance with the associated configurations indicated within the dynamic user profile. An indication of the selection of the task is then fed back to the dynamic user profile to store an indication of the selection (operation 1104).

The embodiments described above can intelligently and automatically predict which tasks of user applications that the user of the mobile device will want to perform, based on historical data stored in the dynamic user profile and a current context of the mobile device, including identifying past tasks taken by the user that are relevant to the current context of the mobile device. Further, the embodiments described above can intelligently and automatically select one service of multiple possible services to be used for performing each of the predicted tasks, according to availability of the various services, past usage of those services as indicated in the dynamic user profile, etc.

The embodiments described above can recommend to the user the predicted tasks through mobile UIs that are presented to the user without activating the user applications. For example, the mobile UIs, when selected by the user, can take the user directly to a UI of the corresponding user application through which the user can initiate the task. As another example, a task can be automatically performed when a mobile UI representing the task is selected by the user.

When the user initiates a recommended task, the task can be performed using the selected service. In this way, the task can be performed through a service integration of various service providers. Moreover, the embodiments described above can provide a unified UI for all service providers providing similar tasks through user applications. Optionally, the embodiments described above can further include an opt-in feature for one or more tasks that the recommendation application would otherwise recommend to the user. This opt-in feature, when enabled by the user for a particular task, may cause the recommendation application to automatically initiate the task when determined by the recommendation application to be relevant to a current context of the mobile device. In one embodiment, the opt-in feature may be provided to the user the first time a task is recommended to the user through a mobile UI, such as within the recommendation UI described above in FIG. 5.

FIG. 12 is a diagram of a network architecture 1200, in accordance with one embodiment. As shown, at least one network 1202 is provided. In various embodiments, any one or more components/features set forth during the description of any previous figure(s) may be implemented in connection with any one or more of the components of the at least one network 1202.

In the context of the present network architecture 1200, the network 1202 may take any form including, but not limited to a telecommunications network, a local area network (LAN), a wireless network, a wide area network (WAN) such as the Internet, peer-to-peer network, cable network, etc. While only one network is shown, it should be understood that two or more similar or different networks 1202 may be provided.

Coupled to the network 1202 is a plurality of devices. For example, a server computer 1212 and a computer 1208 may be coupled to the network 1202 for communication purposes. Such computer 1208 may include a desktop computer, lap-top computer, and/or any other type of logic. Still yet, various other devices may be coupled to the network 1202 including a personal digital assistant (PDA) device 1210, a mobile phone device 1206, a television 1204, etc.

FIG. 13 is a diagram of an exemplary system 1300, in accordance with one embodiment. As an option, the system 1300 may be implemented in the context of any of the devices of the network architecture 1200 of FIG. 12. However, it is to be appreciated that the system 1300 may be implemented in any desired environment.

As shown, a system 1300 is provided including at least one processor 1302 which is connected to a bus 1312. The system 1300 also includes memory 1304 [e.g., hard disk drive, solid state drive, random access memory (RAM), etc.]. The memory 1304 may include one or more memory components, and may even include different types of memory. The system 1300 also includes a display 1310 in the form of a touchscreen, separate display, or the like. Further included is a graphics processor 1308 coupled to the display 1310.

The system 1300 may also include a secondary storage 1306. The secondary storage 1306 includes, for example, a hard disk drive and/or a removable storage drive, representing a floppy disk drive, a magnetic tape drive, a compact disk drive, etc. The removable storage drive reads from and/or writes to a removable storage unit in a well-known manner.

Computer programs, or computer control logic algorithms, may be stored in the memory 1304, the secondary storage 1306, and/or any other memory, for that matter. Such computer programs, when executed, enable the system 1300 to perform various functions (as set forth above, for example). Memory 1304, secondary storage 1306 and/or any other storage comprise non-transitory computer-readable media.

It is noted that the techniques described herein, in an aspect, are embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media are included which may store data that is accessible by a computer, such as magnetic cassettes, flash memory cards, digital video disks, Bernoulli cartridges, random access memory (RAM), read-only memory (ROM), or the like.

As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include one or more of an electronic, magnetic, optical, and electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; or the like.

It should be understood that the arrangement of components illustrated in the Figures described are exemplary and that other arrangements are possible. It should also be understood that the various system components defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that various of the acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein include the one or more modes known to the inventor for carrying out the claimed subject matter. It is to be appreciated that variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A device, comprising:
a non-transitory memory storage comprising instructions; and
one or more processors in communication with the memory, wherein the one or more processors execute the instructions to:
monitor usage of an application to perform a task via a mobile device;
determine configurations of the task via user interfaces (UIs) associated with the usage of the application, the task being performed with the configurations specified according to the UIs;
identify a context of the mobile device, the context including one or more conditions of the mobile device under which the application was activated to perform the task by a user of the mobile device;
track a current context of the mobile device, the current context including one or more conditions in which the mobile device is operating;
determine a relevance between the context and the current context; and
present, in response to the relevance determined, a mobile UI via the mobile device, the mobile UI to cause a repeat of performing the task with the configurations without activating at least one of the UIs associated with the usage of the application.

2. The device of claim 1, wherein the application is a mobile application installed on the mobile device.

3. The device of claim 1, wherein the application is one of:
a messaging application,
a media player,
a merchant store, and
a transportation reservation application.

4. The device of claim 1, wherein the UIs associated with the usage of the application are UIs of the application through which the user navigates to specify the configurations and initiate performance of the task with the configurations.

5. The device of claim 1, further comprising storing an indication of the task with the configurations and the context of the mobile device in a profile for the user, wherein the profile of the user is accessed to identify the context in order to determine the relevance between the context and the current context of the mobile device.

6. The device of claim 1, wherein the context of the mobile device includes one of:
a location of the mobile device, and
a time indicated by the mobile device.

7. The device of claim 1, wherein determining a relevance between the context and the current context includes determining that the current context is within a predefined threshold difference from the context.

8. The device of claim 1, wherein the mobile UI is presented on a home screen of the mobile device.

9. The device of claim 1, wherein the mobile UI presented via the mobile device is an icon which when selected by the user causes the repeat of performing the task with the configurations without activating at least one of the UIs associated with the usage of the application.

10. The device of claim 1, wherein the one or more processors further execute the instructions to:
monitor usage an additional application to perform an additional task via the mobile device;
determine configurations of the additional task via additional user interfaces (UIs) associated with the usage of the additional application, the additional task being performed with the configurations specified according to the additional UIs;
identify an additional context of the mobile device, the additional context including one or more conditions of the mobile device under which the additional application was activated to perform the additional task by the user of the mobile device;
determine an additional relevance between the additional context and the current context; and
present, in combination with the mobile UI and in response to the additional relevance determined, an additional mobile UI via the mobile device, the additional mobile UI to cause a repeat of performing the additional task with the configurations of the additional task without activating at least one of the additional UIs associated with the usage of the additional application.

11. A computer-implemented method, comprising:
monitoring usage of an application to perform a task via a mobile device;
determining configurations of the task via user interfaces (UIs) associated with the usage of the application, the task being performed with the configurations specified according to the UIs;
identifying a context of the mobile device, the context including one or more conditions of the mobile device under which the application was activated to perform the task by a user of the mobile device;
tracking a current context of the mobile device, the current context including one or more conditions in which the mobile device is operating;
determining a relevance between the context and the current context; and
presenting, in response to the relevance determined, a mobile UI via the mobile device, the mobile UI to cause a repeat of performing the task with the configurations without activating at least one of the UIs associated with the usage of the application.

12. The computer-implemented method of claim 11, wherein the application is a mobile application installed on the mobile device.

13. The computer-implemented method of claim 11, wherein the application is one of:
a messaging application,
a media player,
a merchant store, and
a transportation reservation application.

14. The computer-implemented method of claim 11, wherein the UIs associated with the usage of the application are UIs of the application through which the user navigates to specify the configurations and initiate performance of the task with the configurations.

15. The computer-implemented method of claim 11, further comprising storing an indication of the task with the configurations and the context of the mobile device in a profile for the user, wherein the profile of the user is accessed to identify the context in order to determine the relevance between the context and the current context of the mobile device.

16. The computer-implemented method of claim 11, wherein the context of the mobile device includes one of:
a location of the mobile device, and
a time indicated by the mobile device.

17. The computer-implemented method of claim 11, wherein determining a relevance between the context and the current context includes determining that the current context is within a predefined threshold difference from the context.

18. The computer-implemented method of claim 11, wherein the mobile UI is presented on a home screen of the mobile device.

19. The computer-implemented method of claim 11, wherein the mobile UI presented via the mobile device is an icon which when selected by the user causes the repeat of performing the task with the configurations without activating at least one of the UIs associated with the usage of the application.

20. The computer-implemented method of claim 11, further comprising:
monitoring usage an additional application to perform an additional task via the mobile device;
determine configurations of the additional task via additional user interfaces (UIs) associated with the usage of the additional application, the additional task being performed with the configurations specified according to the additional UIs;
identify an additional context of the mobile device, the additional context including one or more conditions of the mobile device under which the additional application was activated to perform the additional task by the user of the mobile device;
determine an additional relevance between the additional context and the current context; and
present, in combination with the mobile UI and in response to the additional relevance determined, an additional mobile UI via the mobile device, the additional mobile UI to cause a repeat of performing the additional task with the configurations of the additional task without activating at least one of the additional UIs associated with the usage of the additional application.

21. A non-transitory computer-readable media storing computer instructions that when executed by one or more processors, cause the one or more processors to perform the steps of:
monitoring usage of an application to perform a task via a mobile device;
determining configurations of the task via user interfaces (UIs) associated with the usage of the application, the task being performed with the configurations specified according to the UIs;
identifying a context of the mobile device, the context including one or more conditions of the mobile device under which the application was activated to perform the task by a user of the mobile device;
tracking a current context of the mobile device, the current context including one or more conditions in which the mobile device is operating;
determining a relevance between the context and the current context; and
presenting, in response to the relevance determined, a mobile UI via the mobile device, the mobile UI to cause a repeat of performing the task with the configurations without activating at least one of the UIs associated with the usage of the application.

22. The computer-implemented method of claim 21, wherein the application is a mobile application installed on the mobile device.

23. The computer-implemented method of claim 21, wherein the application is one of:
a messaging application,
a media player,
a merchant store, and
a transportation reservation application.

24. The computer-implemented method of claim 21, wherein the UIs associated with the usage of the application are UIs of the application through which the user navigates to specify the configurations and initiate performance of the task with the configurations.

25. The computer-implemented method of claim 21, further comprising storing an indication of the task with the configurations and the context of the mobile device in a profile for the user, wherein the profile of the user is accessed to identify the context in order to determine the relevance between the context and the current context of the mobile device.

26. The computer-implemented method of claim 21, wherein the context of the mobile device includes one of:
a location of the mobile device, and
a time indicated by the mobile device.

27. The computer-implemented method of claim 21, wherein determining a relevance between the context and the current context includes determining that the current context is within a predefined threshold difference from the context.

28. The computer-implemented method of claim 21, wherein the mobile UI is presented on a home screen of the mobile device.

29. The computer-implemented method of claim 21, wherein the mobile UI presented via the mobile device is an icon which when selected by the user causes the repeat of performing the task with the configurations without activating at least one of the UIs associated with the usage of the application.

30. The computer-implemented method of claim 21, further comprising:
monitoring usage an additional application to perform an additional task via the mobile device;
determine configurations of the additional task via additional user interfaces (UIs) associated with the usage of the additional application, the additional task being performed with the configurations specified according to the additional UIs;
identify an additional context of the mobile device, the additional context including one or more conditions of the mobile device under which the additional application was activated to perform the additional task by the user of the mobile device;
determine an additional relevance between the additional context and the current context; and
present, in combination with the mobile UI and in response to the additional relevance determined, an additional mobile UI via the mobile device, the additional mobile UI to cause a repeat of performing the additional task with the configurations of the additional task without activating at least one of the additional UIs associated with the usage of the additional application.
